(19) United States
(12) Patent Application Publication
(10) Pub. No.: US 2023/0185614 A1
(43) Pub. Date: Jun. 15, 2023

(54) SYSTEM AND METHOD FOR PROVIDING DECENTRALIZED VEHICLE COMPUTING USING BLOCKCHAIN

(71) Applicant: Honda Motor Co., Ltd., Tokyo (JP)

(72) Inventor: Rajeev CHHAJER, Powell, OH (US)

(21) Appl. No.: 17/547,772

(22) Filed: Dec. 10, 2021

(51) Int. Cl. G06F 9/50; G06F 16/27

(52) U.S. Cl. CPC G06F 9/5027; G06F 16/27; H04L 63/0428; G06Q 20/389

(57) ABSTRACT

A system and method for providing decentralized vehicle computing using blockchain that include determining at least one computing task to be executed to complete a computing operation of a vehicle. The system and method also include accessing the blockchain and analyzing ledgers associated with resource vehicles to be utilized to process the decentralized vehicle computing of the at least one computing task, wherein at least one resource vehicle is determined to be used to execute the at least one computing task. The system and method additionally include controlling computing resources of the at least one resource vehicle to execute the at least one computing task. The system and method further include facilitating a transaction associated with the execution of the at least one computing task by the at least one resource vehicle through the blockchain.

### BACKGROUND

Currently vehicles may include high level and complex computing resources that may be utilized to perform numerous vehicle related operations. Such operations may include navigational operations, mechanical operations, engine related operations, autonomous control operations, and various additional operations that may related to one or more electronic and/or mechanical components of vehicles. However, in many instances particular vehicle computing resources of a particular vehicle may be overwhelmed with a high level of concurrent processes that may be executed to accomplish numerous operations at particular periods of time. In other instances, computing resources of some vehicles may hardly be used during vehicle down times (e.g., while the vehicles are parked) or low execution of operations which may lead to underutilization of such resources.

### BRIEF DESCRIPTION

According to one aspect, a computer-implemented method for providing decentralized vehicle computing using blockchain that includes determining at least one computing task to be executed to complete a computing operation of a vehicle. The computer-implemented method also includes accessing the blockchain and analyzing ledgers associated with resource vehicles to be utilized to process the decentralized vehicle computing of the at least one computing task. At least one resource vehicle is determined to be used to execute the at least one computing task. The computer-implemented method additionally includes controlling computing resources of the at least one resource vehicle to execute the at least one computing task. The computer-implemented method further includes facilitating a transaction associated with the execution of the at least one computing task by the at least one resource vehicle through the blockchain.

According to another aspect, a system for providing decentralized vehicle computing using blockchain that includes a memory storing instructions when executed by a processor cause the processor to determine at least one computing task to be executed to complete a computing operation of a vehicle. The instructions also cause the processor to access the blockchain and analyzing ledgers associated with resource vehicles to be utilized to process the decentralized vehicle computing of the at least one computing task. At least one resource vehicle is determined to be used to execute the at least one computing task. The instructions additionally cause the processor to control computing resources of the at least one resource vehicle to execute the at least one computing task. The instructions further cause the processor to facilitate a transaction associated with the execution of the at least one computing task by the at least one resource vehicle through the blockchain.

According to yet another aspect, a non-transitory computer readable storage medium storing instructions that when executed by a computer, which includes a processor perform a method that includes determining at least one computing task to be executed to complete a computing operation of a vehicle. The method also includes accessing blockchain and analyzing ledgers associated with resource vehicles to be utilized to process the decentralized vehicle computing of the at least one computing task. At least one resource vehicle is determined to be used to execute the at least one computing task. The method additionally includes controlling computing resources of the at least one resource vehicle to execute the at least one computing task. The computer-implemented method further includes facilitating a transaction associated with the execution of the at least one computing task by the at least one resource vehicle through the blockchain.

### BRIEF DESCRIPTION OF THE DRAWINGS

The novel features believed to be characteristic of the disclosure are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The disclosure itself, however, as well as a preferred mode of use, further objects and advances thereof, will be best understood by reference to the following detailed description of illustrative embodiments when read in conjunction with the accompanying drawings, wherein:

FIG. 1 is a schematic view of an exemplary operating environment for providing decentralized vehicle computing using blockchain according to an exemplary embodiment of the present disclosure;

FIG. 2 is a schematic view of a plurality of modules of a vehicle computing application that may execute computer-implemented instructions for providing decentralized vehicle computing using blockchain according to an exemplary embodiment of the present disclosure;

FIG. 3 is a process flow diagram of a method for determining one or more resource vehicles to perform decentralized execution of one or more computing tasks according to an exemplary embodiment of the present disclosure;

FIG. 4 is a process flow diagram of a method for completing decentralizing computing between the vehicle and one or more resource vehicles according to an exemplary embodiment of the present disclosure; and

FIG. 5 is a process flow diagram of a method for providing decentralized vehicle computing using blockchain according to an exemplary embodiment of the present disclosure.

### DETAILED DESCRIPTION

The following includes definitions of selected terms employed herein. The definitions include various examples and/or forms of components that fall within the scope of a term and that can be used for implementation. The examples are not intended to be limiting.

A “bus,’ as used herein, refers to an interconnected architecture that is operably connected to transfer data between computer components within a singular or multiple systems. The bus may be a memory bus, a memory controller, a peripheral bus, an external bus, a crossbar switch, and/or a local bus, among others. The bus may also be a vehicle bus that interconnects components inside a vehicle using protocols such as Controller Area network (CAN), Media Oriented System Transport (MOST), Local Interconnect Network (LIN), among others.

“Computer communication,” as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

An “input device,” as used herein may include devices for controlling different vehicle features which include various vehicle components, systems, and subsystems. The term “input device” includes, but it not limited to: push buttons, rotary knobs, and the like. The term “input device” additionally includes graphical input controls that take place within a user interface which may be displayed by various types of mechanisms such as software and hardware based controls, interfaces, or plug and play devices.

A “memory,” as used herein may include volatile memory and/or nonvolatile memory. Non-volatile memory may include, for example, ROM (read only memory), PROM (programmable read only memory), EPROM (erasable PROM) and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM).

A “module,” as used herein, includes, but is not limited to, hardware, firmware, software in execution on a machine, and/or combinations of each to perform a function(s) or an action(s), and/or to cause a function or action from another module, method, and/or system. A module may include a software controlled microprocessor, a discrete logic circuit, an analog circuit, a digital circuit, a programmed logic device, a memory device containing executing instructions, and so on.

An “operable connection,” as used herein may include a connection by which entities are “operably connected”, is one in which signals, physical communications, and/or logical communications may be sent and/or received. An operable connection may include a physical interface, a data interface and/or an electrical interface.

An “output device,” as used herein may include devices that may derive from vehicle components, systems, subsystems, and electronic devices. The term “output devices” includes, but is not limited to: display devices, and other devices for outputting information and functions.

A “processor,” as used herein, processes signals and performs general computing and arithmetic functions. Signals processed by the processor may include digital signals, data signals, computer instructions, processor instructions, messages, a bit, a bit stream, or other means that may be received, transmitted and/or detected. Generally, the processor may be a variety of various processors including multiple single and multicore processors and co-processors and other multiple single and multicore processor and co-processor architectures. The processor may include various modules to execute various functions.

### I. System Overview

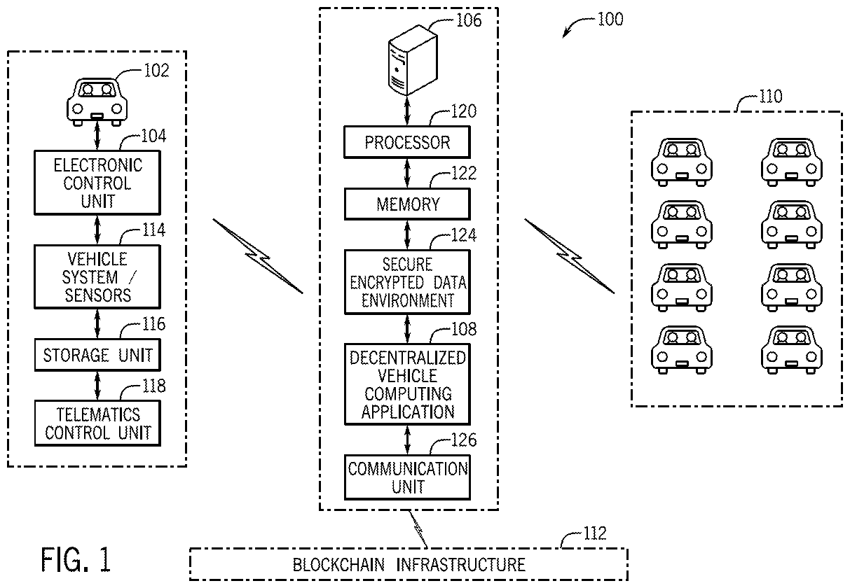

Referring now to the drawings, wherein the showings are for purposes of illustrating one or more exemplary embodiments and not for purposes of limiting the same, FIG. 1 is a schematic view of an exemplary operating environment 100 for providing decentralized vehicle computing using blockchain according to an exemplary embodiment of the present disclosure. In an exemplary embodiment, the operating environment 100 may include a vehicle 102 that may be configured to complete one or computing operations by the ECU 104 of the vehicle 102 by executing one or more computing tasks that are associated with particular computing workloads that are required to be accomplished to execute the one or more computing operations of the vehicle 102 through an electronic control unit 104 of the vehicle 102.

The one or more computing operations that may be completed by the ECU 104 of the vehicle 102 may include, but may not be limited to, operation of one or more electronic components of the vehicle 102, an operation of mechanical components of the vehicle 102, operation of software applications being executed by the vehicle 102, operation of providing safety systems, operation of trajectory planning, operation of autonomous or semi-autonomous control of vehicle 102, and the like. In some configurations, the one or more operations may be completed externally to the vehicle 102 through one or more externally hosted computing environments that may wirelessly communicate with the ECU 104 of the vehicle 102.

As discussed below, the vehicle 102 may be configured to communicate with a secure server infrastructure (secure server) 106 through wireless compute communications between the secure server 106 and the ECU 104 to execute a decentralized vehicle computing application (vehicle computing application) 108 that enables the vehicle 102 to offload the execution of certain computing tasks that are associated with particular computing workloads to one or more resource vehicles 110 to execute the computing tasks. The vehicle computing application 108 may be configured to offload the execution of one or more computing tasks to one or more resource vehicles 110 that may be located within a predetermined vicinity of the vehicle 102 (e.g., within 50 mile radius of the vehicle 102) and that may include requisite computing capabilities (i.e., processing capabilities, storage capability, hardware capability, etc.) to execute one or more particular computing tasks at one or more points in time.

In particular, the vehicle computing application 108 may be configured to identify one or more resource vehicles 110 that may be located within a predetermined vicinity of the vehicle 102 to determine if one or more of the resource vehicles 110 may include available computing resources that have requisite computing capabilities to execute one or more particular computing tasks that may be associated with one or more computing workloads that are to be accomplished to complete one or more respective computing operations of the vehicle 102. This functionality may include determining that one or more resource vehicles 110 that are located within a predetermined vicinity of the vehicle 102 include a requisite amount of processing power, a requisite amount of memory, requisite software that may be executed, and/or requisite hardware (e.g., sensors, vehicle systems, sub-systems) that may be available to complete one or more computing tasks.

Accordingly, the vehicle computing application 108 may utilize underutilized computing resources that may be associated with one or more resource vehicles 110 that have the capability of being utilized to use externally hosted processing power, memory, and hardware in the execution of one or more offloaded computing tasks to enable the vehicle 102 to complete one or more respective computing operations based on the use of decentralized resources. As such, the operation of the vehicle computing application 108 may free up computing resources of the vehicle 102 to more efficiently enable one or more computing tasks to be executed simultaneously externally from the vehicle 102 without utilizing a high amount of processing power, memory utilization, and hardware resources of the vehicle 102. This functionality may promote efficient local hardware independent completion of computing workloads through the offloaded execution of respective computing tasks that may be required to accomplish the completion one or more computing operations of the vehicle 102.

In one or more embodiments, the vehicle computing application 108 may enable one or more stakeholders that may be associated with particular resource vehicles 110 and a stakeholder that may be associated with the vehicle 102 to execute smart contracts that pertain to financial transactions that may be tied to the utilization of the offloading of particular computing tasks to be executed by the computing resources of one or more resource vehicles 110 by the vehicle 102. Such stakeholders may include, an owner/operator of the vehicle 102, respective owners/operators of respective resource vehicles 110, an OEM (e.g., manufacturer) of the vehicle 102, a respective OEM of respective resource vehicles 110, third parties that are associated with the vehicle 102, and/or third parties that are associated with respective resource vehicles 110 (e.g., dealer, ride share company, leasing institution, etc.)

As discussed below, the functionality of identifying one or more resource vehicles 110 that may include available computing resources that have a requisite computing capability to execute one or more particular computing tasks, the sharing of secure data to complete the execution of one or more particular computing tasks, the execution of smart contracts, and the secure payment of financial transactions between stakeholders may be supported by a blockchain infrastructure 112 that may include a blockchain network. The blockchain network may include blocks that may securely store information associated with numerous transactions that may be associated with the utilization of the computing resources of one or more resource vehicles 110 by the vehicle 102 to offload one or more computing tasks to one or more resource vehicles 110.

The vehicle computing application 108 may accordingly provide an improvement in a computer and technology of shared vehicle computing operations by providing a decentralized vehicular computing infrastructure that may extend across fleets of various OEMs to enable shared execution of computing processes between vehicles that are supported by blockchain technology. This functionality may use underutilized computing resources that have the capability of providing unused processing power, memory, software resources, and/or hardware in the execution of one or more particular computing tasks while enabling one or more stakeholders to execute smart contracts and complete associated secure financial transactions that may be tied to the utilization of such underutilized computing resources.

With continued reference to FIG. 1, the vehicle 102 and the resource vehicles 110 may be manufactured by various OEMs and may be powered by one or more forms of energy. For example, the vehicle 102 may be manufactured by a particular OEM and each resource vehicle 110 may be manufactured by the same OEM, a different OEM, or various different OEMs. The vehicle 102 and the resource vehicles 110 may include, but may not be limited to: cars, trucks, vans, minivans, SUVs, motorcycles, scooters, boats, personal watercraft, and aircraft. The vehicle 102 and the resource vehicles 110 may include one or more engines, motors, batteries, that the like that may provide motive power to the vehicle 102 and the resource vehicles 110.

In an exemplary embodiment, the ECU 104 of the vehicle 102 may be configured to perform one or more computing tasks and/or execute processes associated with received data associated with one or more computing tasks that may be executed by one or more resource vehicles 110 to complete one or more computing operations of the vehicle 102. As discussed above, such operations may include, but may not be limited to, operation of one or more electronic components of the vehicle 102, an operation of mechanical components of the vehicle 102, operation of software applications being executed by the vehicle 102, operation of safety systems, operation of trajectory planning, operation of autonomous or semi-autonomous control of vehicle 102, and the like.

The ECU 104 may also be configured to execute one or more applications, operating systems, vehicle system and subsystem user interfaces, among others. In some embodiments, the ECU 104 may execute the vehicle computing application 108. The ECU 104 may be configured to be operably connected to a plurality of additional components of the vehicle 102, including vehicle systems/sensors 114 of the vehicle 102, a storage unit 116 of the vehicle 102, and a telematics control unit (TCU) 118 of the vehicle 102, among other components (not shown in FIG. 1).

In one or more embodiments, the ECU 104 may include a microprocessor, one or more application-specific integrated circuit(s) (ASIC), or other similar devices. The ECU 104 may also include internal processing memory, an interface circuit, and bus lines for transferring data, sending commands, and communicating with the plurality of components of the vehicle 102. The ECU 104 may additionally include a communication device (not shown) for sending data internally within (e.g., between one or more components) the vehicle 102 and communicating with externally hosted computing systems (e.g., external to the vehicle 102).

In one embodiment, the vehicle systems/sensors 114 may include, but may not be limited to, a vehicle autonomous control system, a vehicle alert system, a vehicle navigation system, a vehicle climate control system, a vehicle multimedia system and the like. The vehicle systems/sensors 114 may additionally include, but may not be limited to, image sensors, LiDAR sensors, laser sensors, position sensors, heading sensors, speed sensors, steering speed sensors, steering angle sensors, throttle angle sensors, accelerometers, magnetometers, gyroscopes, yaw rate sensors, brake force sensors, wheel speed sensors, wheel turning angle sensors, transmission gear sensors, temperature sensors, RPM sensors, GPS/DGPS sensors, and the like.

In one or more embodiments, the vehicle systems, sub-systems, and sensors of the vehicle systems/sensors 114 may be utilized by the ECU 104 to complete one or more particular computing operations. Such computing operations may require the completion of computing workloads that may be accomplished by the execution of one or more computing tasks by one or more of the vehicle systems/sensors 114 of the vehicle 102. Based on the functionality of the vehicle computing application 108, some or all of the computing tasks that would be executed by the ECU 104 and/or the vehicle systems/sensors 114 of the vehicle 102 may be requested to be offloaded.

The offload request may be communicated as encrypted task request data through the blockchain infrastructure 112 to utilize the computing resources of one or more resource vehicles 110 that may be located within a predetermined vicinity of the vehicle 102 and that may have the computing capabilities to execute such tasks. As discussed below, the output of the executed computing tasks by one or more respective resource vehicles 110 may be communicated back to the ECU 104 of the vehicle 102 as encrypted task execution data that may be associated with one or more respective computing tasks. The ECU 104 may thereby decrypt the encrypted task execution data associated with one or more respective computing tasks executed by one or more resource vehicles 110 and may utilize the data to complete one or more computing operations.

Generally, the ECU 104 may communicate with the storage unit 116 to execute the one or more applications, operating systems, vehicle system and subsystem user interfaces, and the like that are stored within the storage unit 116. In some embodiments, the storage unit 116 may be configured to store data that may be associated with one or more respective computing tasks that may be executed by one or more resource vehicles 110 to complete one or more computing operations as output by the one or more respective resource vehicles 110. Accordingly, the ECU 104 may be configured to access the storage unit 116 to retrieve such data to be analyzed and executed to complete one or more computing operations at particular points in time.

In an exemplary embodiment, the TCU 118 of the vehicle 102 may be configured to enable the vehicle 102 to connect to externally hosted computing infrastructure and systems including, but not limited to, the secure server 106, the blockchain infrastructure 112, and/or to directly communicate via vehicle to vehicle (V2V) communications with one or more resource vehicles 110. In one or more embodiments, the vehicle computing application 108 may be configured to utilize the TCU 118 to send and/or receive data between the vehicle 102, the secure server 106, and/or the one or more resource vehicles 110. Such data may include encrypted task request data associated with one or more computing tasks that may be requested to be offloaded by the ECU 104 of the vehicle 102, encrypted task execution data that may be received from one or more resource vehicles 110 based on respective computing tasks that may be executed by the one or more resource vehicles 110, smart contract related data, and/or transaction related data that may be exchanged between the vehicle 102, the secure server 106, one or more resource vehicles 110, and/or the blockchain infrastructure 112.

In an exemplary embodiment, the secure server 106 may be configured as a firewall protected secure data intermediary that may be utilized as a gateway to transfer data between the vehicle 102, one or more resource vehicles 110, and the blockchain infrastructure 112. For example, the secure server 106 may be configured as a gateway server that may be utilized to broker transactions associated with outsourcing of the execution of one or more computing tasks between the vehicle 102 and one or more resource vehicles 110. The secure server 106 may be owned, operated, and/or maintained by one or more stakeholders, including, but not limited to, one or more OEMs, a conglomerate of a plurality of OEMs, and/or one or more third parties that may manage decentralized vehicle computing as provided by the vehicle computing application 108.

In one embodiment, one or more components of the secure server 106 may be operably controlled by a processor 120. The processor 120 may be configured to execute one or more operating systems, computing system and subsystem executable instructions, and the like. The processor 120 may also include respective internal processing memory, an interface circuit, and bus lines for transferring data, sending commands, and communicating with the plurality of components of the secure server 106.

In one embodiment, the processor 120 may be operably connected to a memory 122 of the secure server 106. The memory 122 may be configured to store data files associated with one or more applications, operating systems, including but not limited to data files of the vehicle computing application 108. In one embodiment, the memory 122 may be configured to store executable data files that are associated with the vehicle computing application 108. The memory 122 may additionally be configured to store a secure encrypted data environment 124. The secure encrypted data environment 124 may be configured as an encrypted data container that may be accessible based on a selectively and randomly encrypted passcode that may be processed by the processor 120 at one or more periods of time (e.g., every thirty seconds).

In one embodiment, the secure encrypted data environment 124 may allow the encrypted task request data associated with one or more computing tasks that may be requested to be offloaded by the ECU 104 of the vehicle 102 to pass through the secure encrypted data environment 124 to be analyzed by the vehicle computing application 108 and/or be communicated to one or more respective resource vehicles 110 to execute one or more respective computing tasks. The secure encrypted data environment 124 may also be utilized to allow encrypted task execution data that may be associated with one or more respective executed computing tasks executed by and received from one or more resource vehicles 110 to be analyzed by the vehicle computing application 108 and/or be communicated to the vehicle 102 for the ECU 104 to complete one or more computing operations of the vehicle 102.

With continued reference to the secure server 106, the processor 120 of the secure server 106 may also be operably connected to a communication unit 126 of the secure server 106. The communication unit 126 may include one or more network interface cards (not shown) that may be configured to connect to one or more computing systems through an internet cloud (not shown). In particular, the communication unit 126 may be configured to provide secure communications between the secure server 106, the vehicle 102, one or more resource vehicles 110, and the blockchain infrastructure 112. In particular, the communication unit 126 may be configured ensure secure communication of data between the secure server 106 and the blockchain infrastructure 112 to act as a blockchain gateway to facilitate computing task execution transactions between stakeholders associated with the vehicle 102 and one or more resource vehicles 110, to facilitate the execution of one or more smart contracts that pertain to the transactions, and to facilitate the completion of computing task execution transactions between stakeholders based on the offloading of execution of one or more computing tasks by the vehicle 102 to one or more respective resource vehicles 110.

In an exemplary embodiment, the resource vehicles 110 may be operably controlled by respective ECUs (not shown) and may each include similar components to the components of the vehicle 102. For example, each respective resource vehicle 110 may include vehicle systems/sensors, a respective storage unit, and a respective TCU (components of the resource vehicles 110 not shown in FIG. 1). In one configuration, each respective storage unit of each resource vehicle 110 may be configured to store pricing structure data associated with the offloading of particular types of computing tasks to the respective resource vehicle 110.

In particular, the pricing structure data may be associated with price points that may be dynamically set by one or more stakeholders that may be associated with each respective resource vehicle 110 that may be charged to stakeholders that may offload one or more computing tasks to be executed by the respective resource vehicle 110. For example, the pricing structure data may be associated with price points that may be dynamically set by one or more stakeholders that may be associated with each respective resource vehicle 110 that may be charged to a stakeholder that may be associated with the vehicle 102 that may offload one or more computing tasks to be executed by the respective resource vehicle 110 in order for the ECU 104 to complete one or more computing operations.

In some configurations, the pricing structure data may be associated with, but may not be limited to being associated with, a processing speed associated with the ECU of each respective resource vehicle 110, a data storage capacity of each respective resource vehicle 110, computing capabilities of systems and subsystems of each respective resource vehicle 110, hardware capabilities associated with the hardware of each respective resource vehicle 110 (e.g., sensing capabilities associated with sensors of the vehicle 102), software licensing associated with software that may be executed by each resource vehicle 110, and/or the amount of computing power, data, system/subsystem and/or sensor capabilities may be required for one or more particular types of computing tasks (e.g., processing power required to determine traffic related trajectory data at one or more locations in which the respective resource vehicles 110 may be traveling).

In an exemplary embodiment, each ECU of each respective resource vehicle 110 may be configured to process computing resource utilization data, system/subsystem data, sensor data, and profile data. The computing resource utilization data, system/subsystem data, and sensor data processed by the ECU of each of the resource vehicles 110 may include data that pertains to the processing capabilities associated with each resource vehicle 110, memory utilization associated with each resource vehicle 110, system/subsystem capabilities associated with systems and subsystems of each resource vehicle 110, software functionality, and sensor capabilities associated with sensors of each resource vehicle 110. Additionally, the profile data processed by the ECU of each respective resource vehicle 110 may include data that includes a manufacturer, model, model year, vehicle identification number, hardware versions, software versions, and the like that may be associated with each respective resource vehicle 110.

In one embodiment, the vehicle computing application 108 may be configured to analyze the computing resource utilization data, particular system/subsystem data, particular sensor data, profile data, and pricing structure data associated with each respective resource vehicle 110 that may be processed at particular time steps from each respective vehicle 110 to the secure server 106. Upon the analysis of the computing resource utilization data, particular system/subsystem data, particular sensor data, profile data, and pricing structure data, the vehicle computing application 108 may be configured to process a ledger as an encrypted data packet that may store particular data points from the computing resource utilization data, particular system/subsystem data, particular sensor data, profile data, and pricing structure data as received at the particular time stamp from each respective resource vehicle 110.

In one embodiment, each ledger may be processed to include data points that may be extracted from the resource utilization data, particular system/subsystem data, and particular sensor data, including, but not limited to, the operating status of each of the resource vehicles 110, the location (e.g., GPS/DGPS geo-location) of each of the resource vehicles 110, processing power of computing processing resources of each of the resource vehicles 110, data sharing capabilities of each of the resource vehicles 110, memory utilization associated with each of the resource vehicles 110, system/subsystem capabilities associated with systems and subsystems of each of the resource vehicles 110, software functionality of software executed by each of the vehicles 110, sensor capabilities associated with sensors of each of the resource vehicles 110 and availability to complete offloaded computing tasks.

Additionally, each ledger may also include data points that may be extracted from the profile data and the pricing structure data that may include, but may not be limited to, profile information associated with the manufacturer, model, model year, vehicle identification number, hardware versions, software versions, and the like that may be associated with each respective resource vehicle 110 and pricing structure data may be associated with, but may not be limited to being associated with, a processing power (e.g., processing speed) associated with each respective resource vehicle 110, a current memory utilization associated with each respective resource vehicle 110, a data storage capability associated with each respective resource vehicle 110, computing capabilities of systems and subsystems of each respective resource vehicle 110, hardware capabilities associated with the hardware of each respective resource vehicle 110, software licensing associated with software that may be executed by each resource vehicle 110, and/or the amount of computing power, data, system/subsystem and/or sensor capabilities may be required for one or more particular types of computing tasks that may be executed by each respective resource vehicle 110.

In one embodiment, upon processing of each respective ledger the vehicle computing application 108 may be configured to utilize the communication unit 126 to communicate each ledger associated with each respective resource vehicle 110 at particular time stamps to pass each ledger through the blockchain infrastructure 112. Accordingly, respective ledgers that are associated with respective resource vehicles 110 may be passed through the blockchain to be accessed by various stakeholders via the blockchain to potentially selectively offload computing tasks to respective resources vehicles 110 by one or more vehicles, including the vehicle 102.

In one or more embodiments, the blockchain infrastructure 112 may be configured to include one or more externally hosted computing systems that may be owned, operated, and/or hosted by one or more blockchain technology providers. As discussed below, the vehicle computing application 108 may utilize the blockchain infrastructure 112 to pass ledgers associated with each of the resource vehicles 110, pass smart contracts associated with computing task execution transactions between stakeholders associated with the vehicle 102 and one or more resource vehicles 110, and to pass transaction data associated with each of the computing task execution transactions to complete each computing task execution transaction (e.g., financial transaction) in an encrypted and secure manner using blockchain. Accordingly, the vehicle computing application 108 may utilize the blockchain as a backbone that supports the decentralization of vehicle computing to provide a decentralized mobile computing ecosystem that enables the sharing of computing workloads between one or more resource vehicles 110 that may be manufactured by different OEMs to complete one or more computing operations of the vehicle 102.

### II. The Decentralized Vehicle Computing Application and Methods Executed by the Application

The vehicle computing application 108 and its components will now be discussed in more detail according to an exemplary embodiment and with continued reference to FIG. 1. In one or more embodiments, the vehicle computing application 108 may be stored on the memory 122 of the secure server 106 and may be executed by the processor 120 of the secure server 106 in addition to the ECU 104 of the vehicle 102 and the ECUs of respective resource vehicles 110 based on secure wireless computer communications with the communication unit 126 of the secure server 106. In another embodiment, the vehicle computing application 108 may be stored upon the storage unit 116 of the vehicle 102 and respective storage units of resource vehicles 110 to be executed by the ECU 104 of the vehicle 102 and the ECUs of respective resource vehicles 110. In yet another embodiment, the vehicle computing application 108 may be stored on an externally hosted server infrastructure (not shown) or one or more computing systems of the blockchain infrastructure 112 and may be accessed by the secure server 106 through the communication unit 126 to be executed by the processor 120 of the secure server 106.

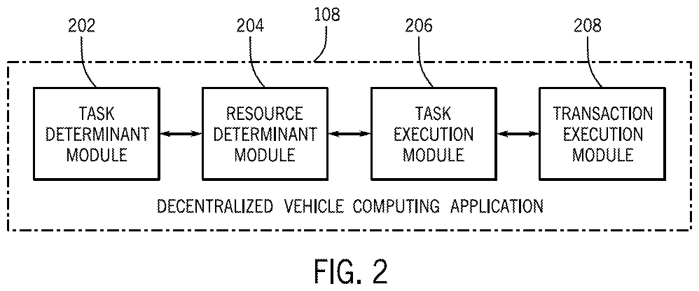

FIG. 2 is a schematic view of a plurality of modules 202-208 of the vehicle computing application 108 that may execute computer-implemented instructions for providing decentralized vehicle computing using blockchain according to an exemplary embodiment of the present disclosure. In an exemplary embodiment, the plurality of modules 202-208 may include a task determinant module 202, a resource determinant module 204, a task execution module 206, and a transaction execution module 208. It is appreciated that the vehicle computing application 108 may include one or more additional modules and/or sub-modules that are included in addition to or in lieu of the modules 202-208.

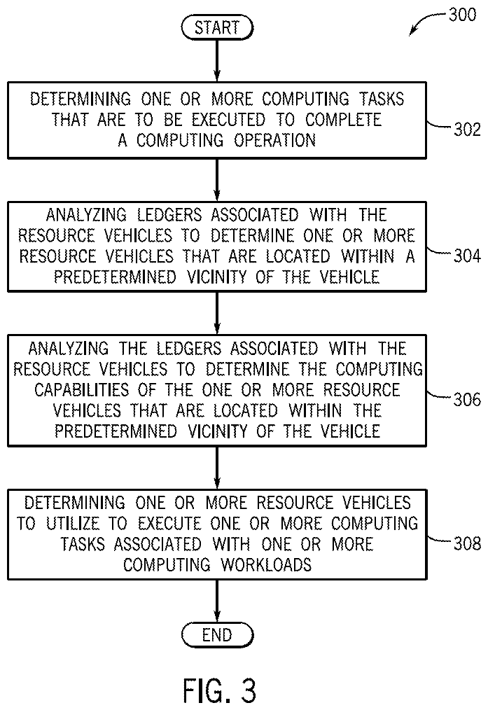

FIG. 3 is a process flow diagram of a method 300 for determining one or more resource vehicles 110 to perform decentralized execution of one or more computing tasks according to an exemplary embodiment of the present disclosure. FIG. 3 will be described with reference to the components of FIG. 1 and FIG. 2, through it is appreciated that the method 300 of FIG. 3 may be used with additional and/or alternative system components. The method 300 may begin at block 302, wherein the method 300 may include determining one or more computing tasks that are to be executed to complete a computing operation.

In an exemplary embodiment, the task determinant module 202 of the vehicle computing application 108 may be configured to communicate with the ECU 104 of the vehicle 102 to determine if the ECU 104 is communicating with the vehicle systems/sensors of the vehicle 102, one or more electronic components, one or more mechanical components, and/or one or more externally hosted computing systems in an effort to complete one or more computing operations. As discussed above, such operations may include, but may not be limited to, operation of one or more electronic components of the vehicle 102, an operation of mechanical components of the vehicle 102, operation of software applications being executed by the vehicle 102, operation of safety systems, operation of trajectory planning, operation of autonomous or semi-autonomous control of vehicle 102, and the like.

In one embodiment, upon determining that the ECU 104 is communicating with the vehicle systems/sensors of the vehicle 102, one or more electronic components, one or more mechanical components, and/or one or more externally hosted computing systems in an effort to complete one or more computing operations, the task determinant module 202 may be configured to communicate with the ECU 104 and/or vehicle systems/sensors 114 to determine one or more computing workloads that are to be accomplished to complete each of the computing operations of the vehicle 102. The task determinant module 202 may thereby evaluate the one or more computing workloads and may determine one or more computing tasks that may be associated to one or more particular computing workloads to be accomplished to complete each computing operation of the vehicle 102. Each computing task may include a computer executable steps (e.g., in computer programmable language, binary code, electronic data format, in algorithmic format, etc.) that may be executed to accomplish each particular type of computing workload that may be required to be executed by particular types of computing components that include particular computing systems, vehicular systems, vehicular sensors, specific software, specific hardware, and the like. Upon determining the one or more computing tasks that may be required to be completed to complete one or more computing operations of the vehicle 102, the task determinant module 202 may communicate data pertaining to the one or more determined computing tasks to the resource determinant module 204 of the vehicle computing application 108.

The method 300 may proceed to block 304, wherein the method 300 may include analyzing ledgers associated with the resource vehicles 110 to determine one or more resource vehicles 110 that are located within a predetermined vicinity of the vehicle 102. In an exemplary embodiment, upon receiving data from the task determinant module 202 that pertains to one or more computing tasks, the resource determinant module 204 of the vehicle computing application 108 may be configured to access the blockchain infrastructure 112 through the communication unit 126 of the secure server 106 and/or the telematics control unit 118 of the vehicle 102 to analyze ledgers that are associated with the resource vehicles 110.

As discussed, the ledgers may be passed to the blockchain infrastructure 112 by the vehicle computing application 108 to allow each of the ledgers to be analyzed to determine one or more resource vehicles 110 that may be utilized to offload computing tasks for various vehicles. Each ledger associated with each resource vehicle 110 may include data points that may be extracted from the resource utilization data, particular system/subsystem data, and particular sensor data, including, but not limited to, the operating status of the resource vehicle 110 (e.g., parked, operating, direction, trajectory), the location (e.g., GPS/DGPS geo-location) of the resource vehicle 110, a processing power associated with each respective resource vehicle 110, a current memory utilization associated with each respective resource vehicle 110, data sharing capabilities of the resource vehicle 110, availability to complete offloaded computing tasks by the computing resources of the resource vehicle 110, profile information associated with the manufacturer (OEM), model, model year, vehicle identification number, hardware versions, software versions, and the like that may be associated with the resource vehicle 110. Each ledger may also include pricing structure data that may be associated with, but may not be limited to being associated with, a processing speed associated with each respective resource vehicle 110, a data storage capability associated with each respective resource vehicle 110, computing capabilities of systems and subsystems of each respective resource vehicle 110, hardware capabilities associated with the hardware of each respective resource vehicle 110 (e.g., sensing capabilities associated with sensors of the vehicle 102), software licensing associated with software that may be executed by each resource vehicle 110, and/or the amount of computing power, data, system/subsystem and/or sensor capabilities may be required for one or more particular types of computing tasks that may be executed by the respective resource vehicle 110.

In an exemplary embodiment, the resource determinant module 204 of the vehicle computing application 108 may be configured to communicate with the vehicle systems/sensors 114 of the vehicle 102 to determine a current geo-location of the vehicle 102. For example, the resource determinant module 204 may be configured to communicate with the navigation system and/or the GPS/DGPS sensors of the vehicle 102 to determine the current GPS/DGPS coordinates associated with the current geo-location of the vehicle 102.

Upon determining the current geo-location of the vehicle 102, the resource determinant module 204 may be configured to access the blockchain infrastructure 112 to analyze the ledgers that are associated with resource vehicles 110 to determine one or more resource vehicles 110 that may be located within the predetermined vicinity of the vehicle 102. As discussed above, the ledgers passed through the blockchain infrastructure 112 that are respectively associated with each of the resource vehicles 110 may include the location (e.g., GPS/DGPS geo-location) of the resource vehicle 110. Accordingly, the resource determinant module 204 may determine one or more resource vehicles 110 that may be available to execute various offloaded computing tasks that may be located within the predetermined vicinity of the vehicle 102. This functionality may ensure that resource vehicles 110 that are utilized to execute one or more computing tasks associated with computing workloads to accomplish one or more computing operations of the vehicle 102 are located within a particular vicinity of the vehicle 102 to enable efficient wireless communication of encrypted task request data and encrypted task execution data.

The method 300 may proceed to block 306, wherein the method 300 may include analyzing the ledgers associated with the resource vehicles 110 to determine the computing capabilities of the one or more resource vehicles 110 that are located within the predetermined vicinity of the vehicle 102. In an exemplary embodiment, upon determining the one or more resource vehicles 110 that may be located within the predetermined vicinity of the vehicle 102, the resource determinant module 204 may specifically analyze the ledgers associated with the one or more resource vehicles 110 that are determined to be located within the vicinity of the vehicle 102 to determine the computing capabilities of each of these resource vehicles 110.

In one embodiment, the resource determinant module 204 may analyze the resource utilization data, particular system/subsystem data, and particular sensor data and may determine computing capabilities of each of the one or more resource vehicles 110 that may be located within the predetermined vicinity of the vehicle 102. The computing capabilities may include determining the processing capabilities, storage capability, hardware capability, of one or more components of each of the resource vehicles 110 and the ability as pertaining to processing requirements, storage requirements, hardware requirements, software requirements, and the like to execute one or more particular types of computing tasks at one or more points in time.

In one embodiment, upon determining the computing capabilities of each of the one or more resource vehicles 110 that may be located within the predetermined vicinity of the vehicle 102, the resource determinant module 204 may be configured to communicate with the ECU 104 of the vehicle 102 to analyze the one or more computing tasks that may be may be required to complete one or more computing operations of the vehicle 102. The resource determinant module 204 may thereby determine one or more particular computing tasks that may be offloaded from the vehicle 102 to available decentralized vehicle computing resources that may be able to execute such tasks based on the determination of the computing capabilities of each of the one or more resource vehicles 110 that may be located within the predetermined vicinity of the vehicle 102.

Stated differently, the resource determinant module 204 may determine computing capabilities that may be required to execute the one or more computing tasks to complete computing operation of the vehicle 102 and may determine which of the one or more computing tasks that are associated with specific computing workloads may be offloaded based on the determined computing capabilities of each of the one or more resource vehicles 110 that may be located within the predetermined vicinity of the vehicle 102 (through the analysis of the ledgers of each of the respective resource vehicles 110 that are located within the predetermined vicinity of the vehicle 102). In particular, the determination of one or more computing tasks that may be offloaded may involve the determination of an amount of processing power, an amount of memory, specific types of hardware (e.g., sensors, vehicle systems, sub-systems), specific type of software/software functionality, and the like that may be required to execute the computing workload(s) associated with the one or more computing tasks.

The method 300 may proceed to block 308, wherein the method 300 may include determining one or more resource vehicles 110 to utilize to execute one or more computing tasks associated with one or more computing workloads. In an exemplary embodiment, upon determining the one or more computing tasks that may be offloaded from the vehicle 102 to one or more resource vehicles 110 that may have the computing capabilities to take on the one or more particular computing tasks, the resource determinant module 204 may specifically analyze the ledgers associated with the one or more resource vehicles 110 that are determined to be located within the vicinity of the vehicle 102 to determine the pricing structure and operating information associated with of these resource vehicles 110.

As discussed above, each ledger associated with each of the resource vehicle 110 that is passed through the through the blockchain infrastructure 112 each include the resource utilization data, particular system/subsystem data, and particular sensor data, including, but not limited to, the operating status of the resource vehicle 110 (e.g., parked, operating, direction, trajectory), the location (e.g., GPS/DGPS geo-location) of the resource vehicle 110, data sharing capabilities of the resource vehicle 110, availability to complete offloaded computing tasks by the computing resources of the resource vehicle 110, profile information associated with the manufacturer (OEM), model, model year, vehicle identification number, hardware versions, software versions, and the like that may be associated with the resource vehicle 110. Each ledger may also include pricing structure data that may be associated with, but may not be limited to being associated with, a processing speed associated with each respective resource vehicle 110, a data storage capability associated with each respective resource vehicle 110, computing capabilities of systems and subsystems of each respective resource vehicle 110, hardware capabilities associated with the hardware of each respective resource vehicle 110 (e.g., sensing capabilities associated with sensors of the vehicle 102), software licensing associated with software that may be executed by each resource vehicle 110, and/or the amount of computing power, data, system/subsystem and/or sensor capabilities may be required for one or more particular types of computing tasks that may be executed by the respective resource vehicle 110.

In one embodiment, based on prior predetermined selections by stakeholder(s) that may be associated with the vehicle 102, an OEM that may be associated with the vehicle 102, and/or based on electronically stored instructions that may be associated with thresholds that may be used to select offloading of one or more computing tasks to resource vehicles 110, the resource determinant module 204 may determine one or more resource vehicles 110 that may be utilized to execute the one or more computing tasks that may be offloaded by the vehicle 102. In other words, based on particular criteria, the resource determinant module 204 may determine which of the one or more of the resource vehicles 110 may include the computing capabilities that may be required to execute the one or more computing tasks to complete the computing operation of the vehicle 102 to be utilized to execute one or more particular tasks for execution.

The criteria that may be evaluated to determine the one or more resource vehicles 110 to utilize to execute one or more computing tasks may include, but may not be limited to, a pricing structure of each of the resource vehicles 110 with respect to the execution of computing tasks, the OEM of each resource vehicle 110, the model/model year of each resource vehicle 110, the operating status of each resource vehicle 110 (e.g., parked during downtime or operating), data sharing capabilities of each resource vehicle 110, and the like. It is appreciated that various additional data points that may be associated with the resource utilization data, the particular system/subsystem data, and the particular sensor data that may be included within each ledger may also be evaluated as criteria that may be used to determine one or more resource vehicles 110 that may be utilized to execute one or more computing tasks.

In an exemplary embodiment, upon determining one or more resource vehicles 110 that may be utilized to execute one or more particular computing tasks, the resource determinant module 204 may be configured to process encrypted task request data associated with the one or more particular computing tasks that may be offloaded from the vehicle 102 to be communicated to one or more particular resource vehicles 110 that may be determined to be utilized to execute the one or more computing tasks. The encrypted task request data may include data points pertaining to one or more task execution computer commands and a respective vehicle identification of one or more resource vehicles 110 that may be utilized to execute the one or more particular computing tasks.

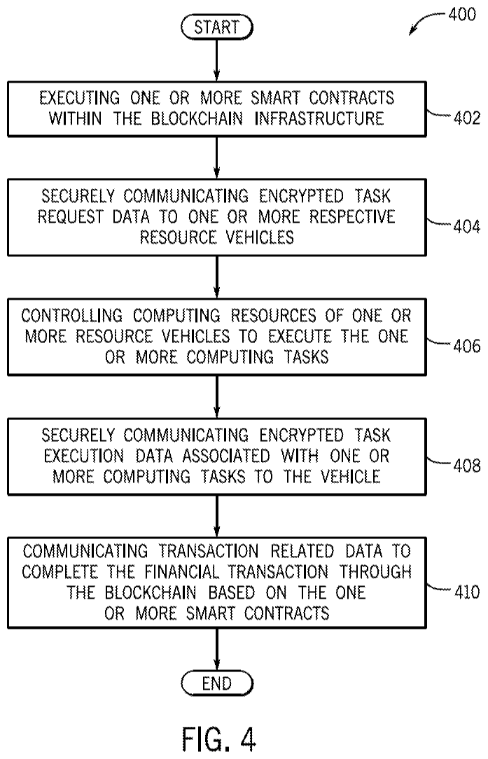

FIG. 4 is a process flow diagram of a method 400 for completing decentralizing computing between the vehicle 102 and one or more resource vehicles 110 according to an exemplary embodiment of the present disclosure. FIG. 4 will be described with reference to the components of FIG. 1 and FIG. 2, through it is appreciated that the method 400 of FIG. 4 may be used with additional and/or alternative system components. The method 400 may begin at block 402, wherein the method 400 may include executing one or more smart contracts within the blockchain infrastructure 112.

In an exemplary embodiment, the task execution module 206 may be configured to execute respective smart contracts that pertain to financial transactions that may be tied to the utilization of the offloading of particular computing tasks to be executed by the computing resources of one or more resource vehicles 110 by the vehicle 102. The respective smart contracts may include the contractual terms that may pertain to price points that may be dynamically set by one or more stakeholders that may be associated with each respective resource vehicle 110 that may be charged to stakeholders that may offload one or more computing tasks to be executed by the respective resource vehicle 110.

As discussed, the price points may be based on pricing structure data that may be associated with, but may not be limited to being associated with, a processing power (e.g., processing speed) associated with each respective resource vehicle 110, a current memory utilization associated with each respective resource vehicle 110, a data storage capability associated with each respective resource vehicle 110, computing capabilities of systems and subsystems of each respective resource vehicle 110, hardware capabilities associated with the hardware of each respective resource vehicle 110, software licensing associated with software that may be executed by each resource vehicle 110, and/or the amount of computing power, data, system/subsystem and/or sensor capabilities may be required to execute one or more particular types of computing tasks by each respective resource vehicle 110 as included with the respective ledger associated with the respective resource vehicle 110. The contractual terms may also include data associated with details that pertain to processing power, memory utilization, hardware utilization, software utilization, software licensing, and the like to be used to execute one or more respective computing tasks.

In one embodiment, upon executing the smart contracts that pertain to financial transactions that may be tied to the utilization of the offloading of particular computing tasks to be executed by the computing resources of one or more resource vehicles 110 by the vehicle 102 between the one or more stakeholders that may be associated with particular resource vehicles 110 and a stakeholder that may be associated with the vehicle 102, the task execution module 206 may be configured to pass the smart contracts through the blockchain infrastructure 112 to be securely communicated between the respective stakeholders. In some embodiments, the smart contracts may be passed as encrypted smart contract related data that may be decrypted locally by the respective stakeholders upon retrieval of such data from the blockchain infrastructure 112.

The method 400 may proceed to block 404, wherein the method 400 may include securely communicating encrypted task request data to one or more respective resource vehicles 110. In an exemplary embodiment, upon the execution of one or more smart contracts between the one or more stakeholders that may be associated with particular resource vehicles 110 that may be determined to be utilized to execute one or more particular computing tasks and the stakeholder that may be associated with the vehicle 102, the task execution module 206 may be configured to securely communicate the respective encrypted task request data from the vehicle 102 to the one or more respective resource vehicles 110.

As discussed, the encrypted task request data may include data points pertaining to one or more task execution computer commands and a respective vehicle identification of one or more resource vehicles 110 that may be utilized to execute the one or more particular computing tasks. In one embodiment, the task execution module 206 may be configured to pass the encrypted task request data associated with one or more computing tasks that may be requested to be offloaded by the ECU 104 of the vehicle 102 through the blockchain infrastructure 112 to be communicated securely through the blockchain from the vehicle 102 to one or more respective vehicles 110 that are determined to be utilized to execute one or more respective computing tasks. Accordingly, the encrypted task request data may be passed through the blockchain infrastructure 112 to be retrieved by one or more resource vehicles 110 to be analyzed to determine the one or more task execution computer commands to execute the one or more particular computing tasks.

In another embodiment, the secure encrypted data environment 124 of the secure server 106 may be utilized by the task execution module 206 to securely pass the encrypted task request data associated with one or more computing tasks that may be requested to be offloaded by the ECU 104 of the vehicle 102 directly to the one or more respective resource vehicles 110 that are determined to be utilized to execute one or more respective computing tasks. Accordingly, the encrypted task request data may be passed through the secure encrypted data environment 124 to be communicated to one or more resource vehicles 110 to be analyzed to determine the one or more task execution computer commands to execute the one or more particular computing tasks.

The method 400 may proceed to block 406, wherein the method 400 may include controlling computing resources of one or more resource vehicles 110 to execute the one or more computing tasks. In one embodiment, the task execution module 206 may be configured to send one or more commands to the respective computing resources to analyze the encrypted task request data to utilize the respective computing resources of each of the one or more respective resource vehicles 110 that are determined to be utilized to execute one or more respective computing tasks to execute each respective computing task. Accordingly, the computing resources of each respective resource vehicle 110 including, but not limited to, the ECU, microprocessor(s), storage unit/memory, systems, sub-systems, sensors, electrical components, mechanical components, executed software, and/or additional components of the respective resource vehicle 110 may be utilized to execute the one or more respective computing tasks that may be associated with computing workloads that are to be accomplished to complete one or more computing operations of the vehicle 102. As such, the task execution module 206 may utilize underutilized computing resources that may be associated with one or more resource vehicles 110 that have the capability of being utilized to use externally hosted processing power, memory, and hardware in the execution of one or more offloaded computing tasks to enable the vehicle 102 to complete one or more respective computing operations.

With continued reference to the method 400 of FIG. 4, the method 400 may proceed to block 408, wherein the method 400 may include securely communicating encrypted task execution data associated with one or more computing tasks to the vehicle 102. In an exemplary embodiment, upon the computing resources of the one or more resource vehicles 110 executing one or more respective computing tasks, the task execution module 206 may operably control the one or more computing resources to output the executed computing tasks from one or more of the respective resource vehicles 110 as encrypted task execution data. The encrypted task execution data may be communicated as an encrypted data package that includes executable steps (e.g., in computer programmable language, binary code, electronic data format, in algorithmic format, etc.) that is associated with output of computing workloads (e.g., autonomous instruction, trajectory prediction data, safety alert data, vehicle electronic instruction data, and the like) to accomplish the completion of one or more computing operations by the vehicle 102.

In one embodiment, the task execution module 206 may be configured to pass the encrypted task execution data associated with one or more executed computing tasks to be communicated securely through the blockchain from the one or more respective vehicles 110 that have executed the one or more respective computing tasks to the vehicle 102. Accordingly, the encrypted task execution data may be passed through the blockchain infrastructure 112 to be retrieved by the vehicle 102. The ECU 104 of the vehicle 102 may thereby decrypt the encrypted task execution data associated with one or more respective computing tasks executed by one or more resource vehicles 110 and may utilize the data to complete one or more computing operations.

In another embodiment, the secure encrypted data environment 124 of the secure server 106 may be utilized by the task execution module 206 to securely pass the encrypted task execution data associated with one or more computing tasks that may be requested to be offloaded by the ECU 104 of the vehicle 102 directly to the one or more respective resource vehicles 110 that are determined to be utilized to execute one or more respective computing tasks. Accordingly, the encrypted task execution data may be passed through the secure encrypted data environment 124 to be communicated to the vehicle 102. The ECU 104 of the vehicle 102 may thereby decrypt the encrypted task execution data associated with one or more respective computing tasks executed by one or more resource vehicles 110 and may utilize the data to complete one or more computing operations.

The method 400 may proceed to block 410, wherein the method 400 may include communicating transaction related data to complete the financial transaction through the blockchain based on the one or more smart contracts. In an exemplary embodiment, upon the communication of encrypted task execution data, the task execution module 206 may communicate data pertaining to the offloaded execution of the one or more computing tasks by one or more resource vehicles 110 to the transaction execution module 208 of the vehicle computing application 108. The transaction execution module 208 may be configured to analyze the one or more smart contracts that have been executed between one or more stakeholders that may be associated with particular resource vehicles 110 and the stakeholder that may be associated with the vehicle 102.

As discussed, the one or more smart contracts may pertain to financial transactions that may be tied to the utilization of the offloading of particular computing tasks to be executed by the computing resources of one or more resource vehicles 110 by the vehicle 102. In one embodiment, the transaction execution module 208 may thereby process transaction data that pertains to the financial transactions included within one or more respective smart contracts. The transaction data may include, but may not be limited to, a monetary transfer amount, account information, wiring information, routing information, and the like associated with the financial transaction from the stakeholder that may be associated with the vehicle 102 to one or more stakeholders that may be associated with particular resource vehicles 110 that have executed one or more particular computing tasks.

Accordingly, the transaction execution module 208 may be configured to pass the transaction data through the blockchain infrastructure 112 that pertains to the completion of the financial transactions that may be tied to the utilization of the offloading of particular computing tasks to be executed by the computing resources of one or more resource vehicles 110 by the vehicle 102 to mine the transaction and verify it towards payment.

In one or more configurations, transaction data associated with the financial transaction between the stakeholders may be further verified through the blockchain technologies to complete the secure transaction and secure payment of funds from the stakeholder that may be associated with the vehicle 102 to one or more stakeholders that may be associated with particular resource vehicles 110 that have executed one or more particular computing tasks. The blockchain infrastructure 112 may communicate a confirmation to the transaction execution module 208 of the blockchain verification. Upon the receipt of the confirmation, the transaction execution module 208 may confirm the transaction has been securely completed. Accordingly, the vehicle computing application 108 may ensure that the secure transaction between the stakeholder that may be associated with the vehicle 102 to one or more stakeholders that may be associated with particular resource vehicles 110 is securely validated from an initiation point to a final payment point.

Accordingly, the operation of the vehicle computing application 108 may free up computing resources of the vehicle 102 to more efficiently enable one or more computing tasks to be executed simultaneously externally from the vehicle 102 without utilizing a high amount of processing power, memory utilization, and hardware resources of the vehicle 102. This functionality may promote efficient local hardware independent completion of computing workloads through the offloaded execution of respective computing tasks that may be required to accomplish the completion one or more computing operations of the vehicle 102.

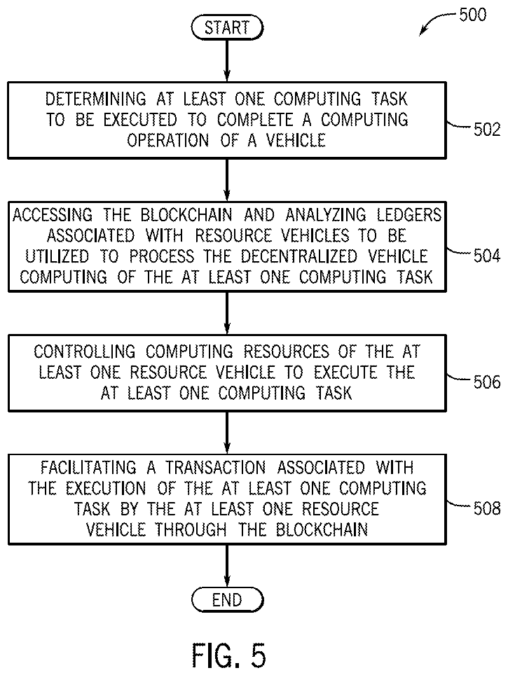

FIG. 5 is a process flow diagram of a method 500 for providing decentralized vehicle computing using blockchain according to an exemplary embodiment of the present disclosure. FIG. 5 will be described with reference to the components of FIG. 1 and FIG. 2, through it is appreciated that the method 500 of FIG. 5 may be used with additional and/or alternative system components.

The method 500 may begin at block 502, wherein the method 500 may include determining at least one computing task to be executed to complete a computing operation of a vehicle 102. The method 500 may proceed to block 504, wherein the method 500 may include accessing the blockchain and analyzing ledgers associated with resource vehicles 110 to be utilized to process the decentralized vehicle computing of the at least one computing task. In one embodiment, at least one resource vehicle 110 is determined to be used to execute the at least one computing task.

The method 500 may proceed to block 506, wherein the method 500 may include controlling computing resources of the at least one resource vehicle to execute the at least one computing task. The method 500 may proceed to block 508, wherein the method 500 may include facilitating a transaction associated with the execution of the at least one computing task by the at least one resource vehicle through the blockchain.

It should be apparent from the foregoing description that various exemplary embodiments of the disclosure may be implemented in hardware. Furthermore, various exemplary embodiments may be implemented as instructions stored on a non-transitory machine-readable storage medium, such as a volatile or non-volatile memory, which may be read and executed by at least one processor to perform the operations described in detail herein. A machine-readable storage medium may include any mechanism for storing information in a form readable by a machine, such as a personal or laptop computer, a server, or other computing device. Thus, a non-transitory machine-readable storage medium excludes transitory signals but may include both volatile and non-volatile memories, including but not limited to read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

It will be appreciated that various implementations of the above-disclosed and other features and functions, or alternatives or varieties thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A computer-implemented method for providing decentralized vehicle computing using blockchain comprising:
determining at least one computing task to be executed to complete a computing operation of a vehicle;
accessing the blockchain and analyzing ledgers associated with resource vehicles to be utilized to process the decentralized vehicle computing of the at least one computing task, wherein at least one resource vehicle is determined to be used to execute the at least one computing task;
controlling computing resources of the at least one resource vehicle to execute the at least one computing task; and
facilitating a transaction associated with the execution of the at least one computing task by the at least one resource vehicle through the blockchain.

2. The computer-implemented method of claim 1, wherein determining the at least one computing task includes determining at least one computing workload that is to be accomplished to complete the computing operation of the vehicle, wherein the at least one computing task includes computer executable steps that are executed by particular computing components to accomplish the at least one computing workload.

3. The computer-implemented method of claim 1, wherein accessing the blockchain and analyzing the ledgers include analyzing the ledgers that are passed through the blockchain to determine a current geo-location of each of the resource vehicles to determine resource vehicles that are located within a predetermined vicinity of the vehicle.

4. The computer-implemented method of claim 3, wherein the ledgers associated with the resource vehicles that are located within the predetermined vicinity of the vehicle are analyzed to determine the at least one resource vehicle that is located within the predetermined vicinity of the vehicle and that includes requisite computing capabilities to execute the at least one computing task.

5. The computer-implemented method of claim 4, further including analyzing computing tasks that are required to be executed by the vehicle to complete the computing operation of the vehicle and determining the at least one computing task to be offloaded to the at least one resource vehicle based on the computing capabilities of the at least one resource vehicle as determined based on the analysis of the ledger accessed through the blockchain.

6. The computer-implemented method of claim 4, further including executing at least one smart contract that includes contractual terms that pertain to the transaction associated with the execution of the at least one computing task by the at least one resource vehicle through the blockchain.

7. The computer-implemented of claim 6, further including securely communicating encrypted task request data that pertains to a request to offload the computing task from the vehicle to the at least one resource vehicle, wherein the secure communication of encrypted task request data is completed by passing the encrypted task request data from the vehicle to the at least one resource vehicle through the blockchain.

8. The computer-implemented of claim 6, further including securely communicating encrypted task execution data upon the completed execution of the at least one computing task by the at least one resource vehicle that pertains to an executed computing task from the at least one resource vehicle to the vehicle, wherein the secure communication of encrypted task execution data is completed by passing the encrypted task execution data from the at least one resource vehicle to the vehicle through the blockchain.

9. The computer-implemented method of claim 6, wherein facilitating the transaction associated with the execution of the at least one computing task includes passing transaction data associated with the transaction based on the contractual terms included within the at least one smart contract that are associated with the execution of the at least one computing task by the at least one resource vehicle through the blockchain.

10. A system for providing decentralized vehicle computing using blockchain comprising:
a memory storing instructions when executed by a processor cause the processor to:
determine at least one computing task to be executed to complete a computing operation of a vehicle;
access the blockchain and analyzing ledgers associated with resource vehicles to be utilized to process the decentralized vehicle computing of the at least one computing task, wherein at least one resource vehicle is determined to be used to execute the at least one computing task;
control computing resources of the at least one resource vehicle to execute the at least one computing task; and
facilitate a transaction associated with the execution of the at least one computing task by the at least one resource vehicle through the blockchain.

11. The system of claim 10, wherein determining the at least one computing task includes determining at least one computing workload that is to be accomplished to complete the computing operation of the vehicle, wherein the at least one computing task includes computer executable steps that are executed by particular computing components to accomplish the at least one computing workload.

12. The system of claim 10, wherein accessing the blockchain and analyzing the ledgers include analyzing the ledgers that are passed through the blockchain to determine a current geo-location of each of the resource vehicles to determine resource vehicles that are located within a predetermined vicinity of the vehicle.

13. The system of claim 12, wherein the ledgers associated with the resource vehicles that are located within the predetermined vicinity of the vehicle are analyzed to determine the at least one resource vehicle that is located within the predetermined vicinity of the vehicle and that includes requisite computing capabilities to execute the at least one computing task.

14. The system of claim 13, further including analyzing computing tasks that are required to be executed by the vehicle to complete the computing operation of the vehicle and determining the at least one computing task to be offloaded to the at least one resource vehicle based on the computing capabilities of the at least one resource vehicle as determined based on the analysis of the ledger accessed through the blockchain.

15. The system of claim 13, further including executing at least one smart contract that includes contractual terms that pertain to the transaction associated with the execution of the at least one computing task by the at least one resource vehicle through the blockchain.

16. The system of claim 15, further including securely communicating encrypted task request data that pertains to a request to offload the computing task from the vehicle to the at least one resource vehicle, wherein the secure communication of encrypted task request data is completed by passing the encrypted task request data from the vehicle to the at least one resource vehicle through the blockchain.

17. The system of claim 15, further including securely communicating encrypted task execution data upon the completed execution of the at least one computing task by the at least one resource vehicle that pertains to an executed computing task from the at least one resource vehicle to the vehicle, wherein the secure communication of encrypted task execution data is completed by passing the encrypted task execution data from the at least one resource vehicle to the vehicle through the blockchain.

18. The system of claim 15, wherein facilitating the transaction associated with the execution of the at least one computing task includes passing transaction data associated with the transaction based on the contractual terms included within the at least one smart contract that are associated with the execution of the at least one computing task by the at least one resource vehicle through the blockchain.

19. A non-transitory computer readable storage medium storing instruction that when executed by a computer, which includes a processor perform a method, the method comprising:
determining at least one computing task to be executed to complete a computing operation of a vehicle;
accessing blockchain and analyzing ledgers associated with resource vehicles to be utilized to process decentralized vehicle computing of the at least one computing task, wherein at least one resource vehicle is determined to be used to execute the at least one computing task;
controlling computing resources of the at least one resource vehicle to execute the at least one computing task; and
facilitating a transaction associated with the execution of the at least one computing task by the at least one resource vehicle through the blockchain.

20. The non-transitory computer readable storage medium of claim 19, wherein facilitating the transaction associated with the execution of the at least one computing task includes passing transaction data associated with the transaction based on contractual terms included within at least one smart contract that are associated with the execution of the at least one computing task by the at least one resource vehicle through the blockchain.
